(19) United States
(12) Patent Application Publication
(10) Pub. No.: US 2024/0358056 A1
(43) Pub. Date: Oct. 31, 2024

(54) Systems and Methods for Removing a Covering From An Item of Produce

(71) Applicant: Atlas Pacific Engineering Company, Pueblo, CO (US)

(72) Inventors: John William Renz, Lakewood, CO (US); Jennifer Marie Weber, Englewood, CO (US)

(21) Appl. No.: 18/645,630

(22) Filed: Apr. 25, 2024

Related U.S. Application Data
(60) Provisional application No. 63/498,860, filed on Apr. 28, 2023.

(51) Int. Cl. A23N 5/08; A23N 7/02

(52) U.S. Cl. CPC A23N 5/08; A23N 7/023

(57) ABSTRACT

Systems and methods are provided for removing a covering from produce. An example system includes a structure for supporting a plurality of rollers, the structure being configured to turn a first roller and a second roller. The first roller comprises a first plurality of gear shaped structures, and the second roller comprises a second plurality of gear shaped structures. The first and second gear shaped structures are configured to contact the produce and remove the covering from the produce when the first roller and the second roller are turned.

### CROSS-REFERENCE TO RELATED APPLICATIONS

This application claims priority to U.S. Provisional Application No. 63/498,860, filed Apr. 28, 2023, which is incorporated herein by reference in its entirety.

### BACKGROUND

Items of produce, such as fruits, vegetables, and nuts, often grow in a configuration that substantially differs from how it is stored, transported, sold, or consumed. For example, in some instances it may be desirable to remove produce coverings (e.g., potato or carrot outer layers or skins; pistachio hulls (mesocarps)) during a produce processing phase. Covering removal can provide functional advantages, such as making the produce easier to dry, preserve, or store. In some instances, covering removal can provide appearance benefits, making the produce more attractive to the consumer.

### SUMMARY

Systems and methods are provided for removing a covering from produce. An example system includes a structure for supporting a plurality of rollers, the structure being configured to turn a first roller and a second roller. The first roller comprises a first plurality of gear shaped structures, and the second roller comprises a second plurality of gear shaped structures. The first and second gear shaped structures are configured to contact the produce and remove the covering from the produce when the first roller and the second roller are turned.

In another example, a method for removing a covering from produce includes providing a structure for supporting a plurality of rollers. A first roller is turned in a first direction, and a second roller is turned in the same direction as the first roller, where the first roller comprises a first plurality of gear shaped structures, and where the second roller comprises a second plurality of gear shaped structures. Produce is provided to the structure such that certain of the first and second gear shaped structures contact the produce and remove the covering from the produce when the first roller and the second roller are turned in the same direction.

### BRIEF DESCRIPTION OF DRAWINGS

FIG. 1 is a process for processing produce to remove a covering from produce.

FIG. 2 is a diagram depicting an example produce hull remover for removing a covering from one or more items of produce.

FIG. 3 is a diagram depicting an example produce hull remover that includes a plurality of rollers.

FIG. 4 is a diagram depicting an example roller having gear shaped structures thereon.

FIG. 5 is a diagram depicting a close up view of the second end of the roller.

FIG. 6 is a diagram depicting an example gear shaped structure and an item of produce being processed.

FIG. 7 is a diagram depicting example staggering of gear shaped structures across neighboring rollers.

FIG. 8 is a diagram depicting items of produce being processed to remove coverings by gear shaped structures on first and second rolls.

FIG. 9 is a diagram depicting tooth impact zones that are controlled via gear tooth spacing.

FIG. 10 depicts an end of a system for removing a covering from items of produce.

FIG. 11 is a flow diagram depicting a method for removing a covering from produce.

### DETAILED DESCRIPTION

System and methods as described herein provide techniques for processing produce including removing a covering for produce. As noted above, covering removal can provide functional benefits, such as enhanced ability to dry and preserve the produce or increase ease of access to the desired portion of produce. Covering removal can also provide aesthetic benefits (e.g., removing skin or a dirt outer layer), making the produce more attractive to consumers. Certain examples are described herein using removal of pistachio hulls (mesocarps), but those systems and methods may be equally applied to other produce, such as nuts, potatoes, baby carrots, or any other produce item that has a covering that might be desirable to remove.

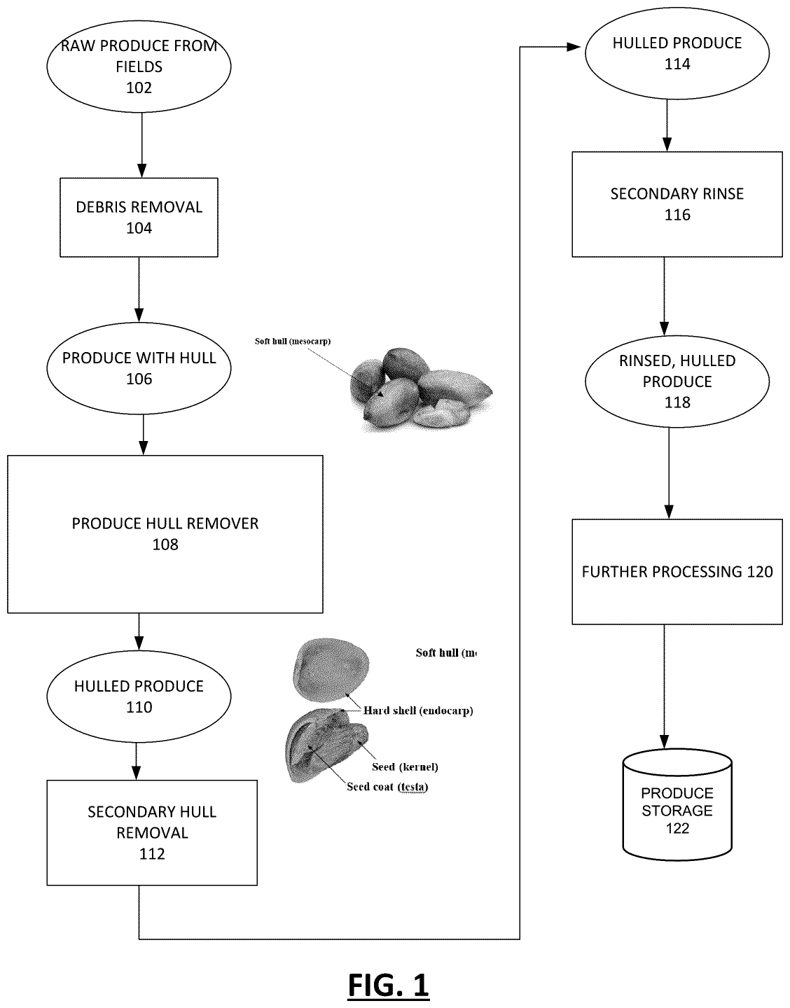

FIG. 1 is a process for processing produce to remove a covering from produce. At 102, produce is received in raw form. For example, pistachios may be received in grape-like clusters that each contain 30-50 pistachios. In some instances, portions of branches may still be connected to those received clusters. An initial debris removal may be performed at 104 to remove unwanted material, such as branches and cluster connective material, so that the pistachios are further processed in substantially individual form at 106. Some pistachios at this point may have had their hulls fall off by this point. But many pistachios will still have that hull covering (e.g., a soft, red mesocarp) present over a hard endocarp shell with a seed (kernel) and seed covering (testa) therein). At 108, the produce with its hull intact is processed to remove the hull such that hulled produce 110 is output from the processing step (e.g., so that only the pistachio endocarp, seed, and seed covering remain). In some examples, further processing may be performed to ensure that hull removal is complete or substantially complete from the population of input produce. In an example, secondary hull removal (e.g., via rotating, physical paddles, high pressure wash water) is performed at 112 to provide a greater percentage of hulled produce at 114. A further rinse (e.g., using low or high pressure wash water) may be performed to remove unwanted debris or other unwanted substances). Rinsed, hulled produce 118 may be packaged, sliced, diced, dried or otherwise preserved at 120 (e.g., pistachios may be dried, baby carrots packaged, potatoes and onions sliced or diced). Dried or otherwise preserved produce will be placed in storage (e.g., in a storage silo) at 122.

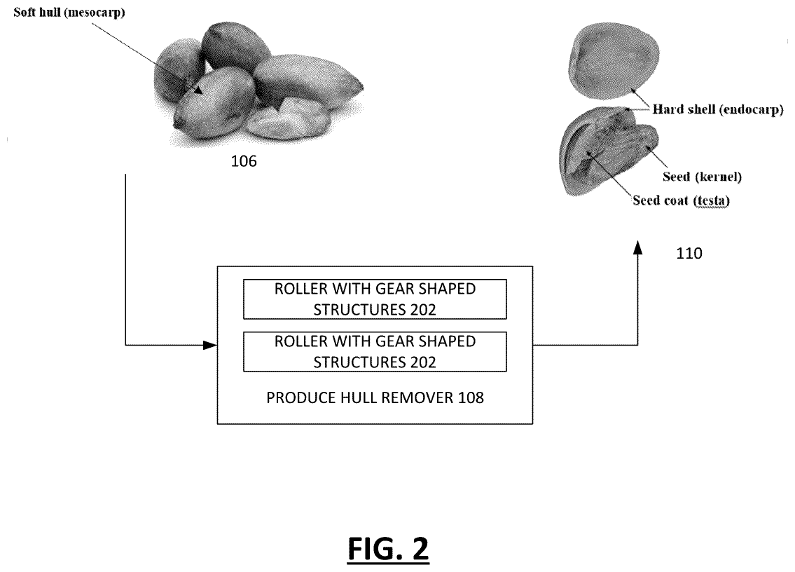

FIG. 2 is a diagram depicting an example produce hull remover for removing a covering from one or more items of produce. A produce hull remover 108 includes a structure that supports a plurality of rollers 202. The structure of the hull remover 108 is configured to turn a first roller and a second roller, where the first roller comprises a first plurality of gear shaped structures, and where the second roller comprises a second plurality of gear shaped structures. One or more items of produce 106 are provided to the structure of the produce hull remover 108 such that certain of the first and second gear shaped structures contact the produce 106 and remove the covering from the produce when the first roller and the second roller are turned. Hulled produce 110 is output from the hull remover 108 for downstream processing, which may include one or more of further hull removing, washing, drying, preserving, and storing.

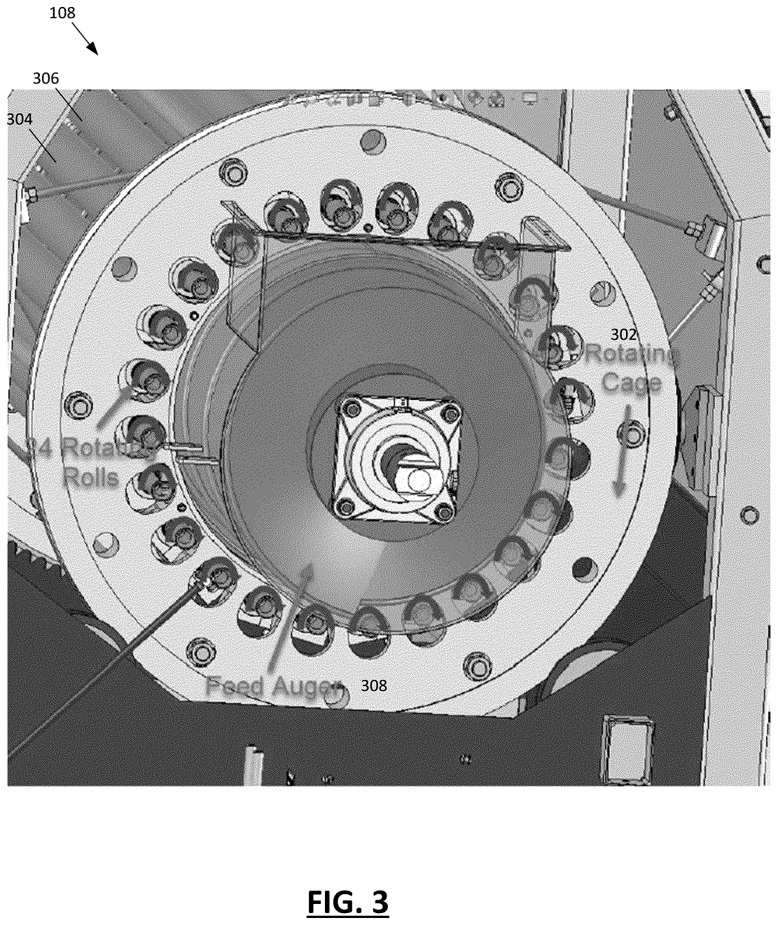

FIG. 3 is a diagram depicting an example produce hull remover that includes a plurality of rollers. The hull remover 108 for removing a covering from produce includes a structure 302 for supporting a plurality of rollers (e.g., first roller 304 and second roller 306). The structure 302 is configured to turn all rollers 304 in a clockwise direction and the roll cage structure 302 turns in a clockwise direction as indicated by arrows. The example of FIG. 3 includes 24 rollers turning in the same direction. A feed auger 308 is positioned at the center of the structure 302 and is configured to transit produce from a first end of the structure 302 (back end, not shown) to a second end of the structure 302 (front end visible in FIG. 3), such as via a screw shape that turns within the feed auger. Produce introduced into the structure 302 at the first end contacts the turning rollers, typically contacting rollers near the bottom of the structure. In embodiments, the structure 302 itself rotates (e.g., forming a rotating cage around the produce therein), thus cycling the turning rollers through the bottom positions where contact with the produce is most likely. Rotation of the structure 302 provides more even wear on the rollers and limits instances where produce becomes stuck between the rollers.

The rollers (e.g., first roller 304 and second roller 306) are structured to impart a separating force on the covering of the produce when the produce is contacted by the rollers, typically neighboring rollers turning in the same direction. In an embodiment, each of the rollers includes a plurality of gear shaped structures separated by gaps. The gear shaped structures are configured to contact the produce and remove the covering from the produce (e.g., when the first roller and the second roller are turned in the same direction). For example, two gear shaped structures on the first roller 304 and one gear shaped structure on the second roller 306 may contact a pistachio at one time, and when those rollers 304, 306 are turned in the same direction, a pushing force may be imparted by one roller and a pulling force may be imparted by the adjacent roller on the hull that strips the hull from the pistachio. That stripping force may in some instances eject hull to the exterior of the structure 302 for collection and disposal.

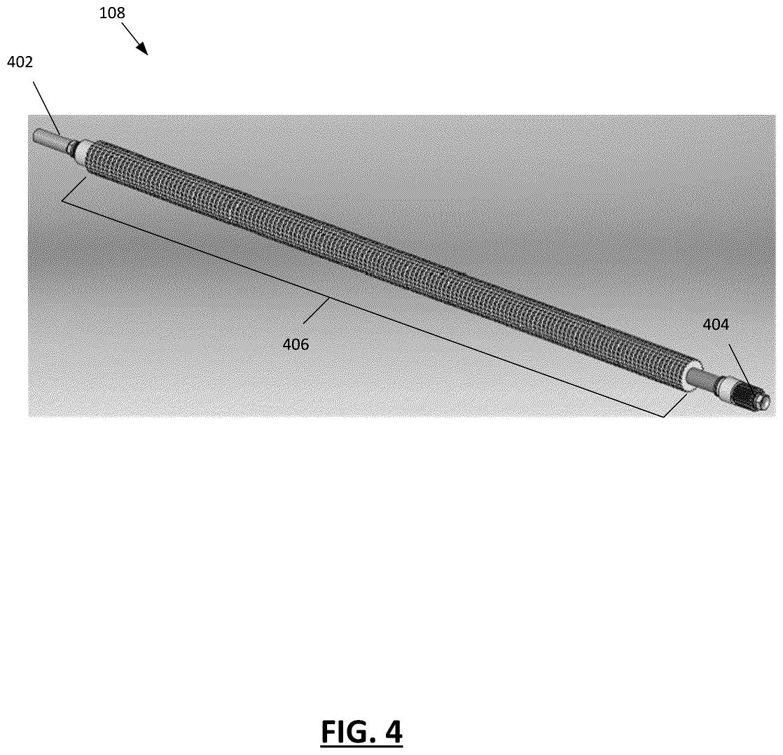

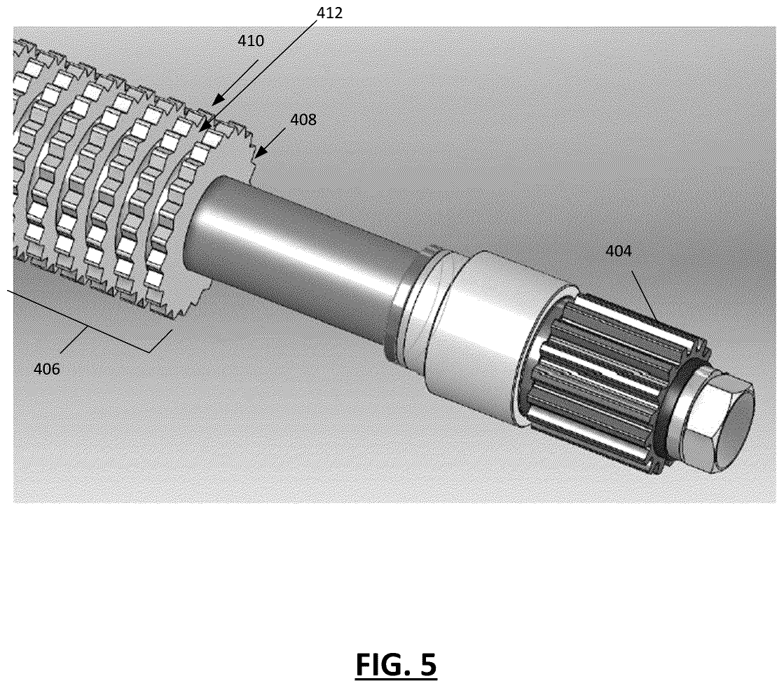

FIG. 4 is a diagram depicting an example roller having gear shaped structures thereon. The example roller 304 includes a first end 402 having a smooth surface for receipt at the far end of the supporting structure. The smooth surface enables free turning of the roller 304, such as when the first end 402 is inserted into a first aperture of the supporting structure. A second end 404 of the roller 304 has a gear shape (shown in further detail in FIG. 5). When inserted into a second aperture at the near end of the supporting structure, the gear shape at the second end 404 may be engaged by a driving gear to import a force that turns the roller 404. A central portion of the roller includes a plurality of gear shaped structures separated from one another by gaps. The gear shaped structures and/or spacers in between those gear shaped structures to form the gaps may, in embodiments, be formed from a hard wear resistant material, such as ceramic, stainless metal, metal, durable polymer or other durable food safety material. The use of such hardened, food safe materials can reduce maintenance required by component wear and can significantly reduce downstream water usages, such as rinse requirements necessitated by use of materials that are more susceptible to wear or less food-safe.

FIG. 5 is a diagram depicting a close up view of the second end of the roller. As noted above, the second end 404 of the roller 304 includes a gear via which a force may be imparted to turn the roller 304 in a prespecified direction (e.g., continuously, substantially continuously). FIG. 5 further illustrates a plurality of gear shaped structures 408, 410 separated from one another by a gap 412 along a central portion 406 of the roller. The width of the gear shaped structures 408, 410 and the gap 412 may be based on an average size of an item of produce expected to be processed. The width of the gap 412 may be the same or close to the same as the width of one of the gear shaped structures 408, 410, such that, when positioned in a staggered fashion relative to a neighboring roller 306, gaps of the first roller 304 are aligned with gear shaped structures of the second roller and gaps of the second roller 304 are aligned with gear shaped structures of the first roller 304. Lateral spacing of the gear shaped structures 408, 410 along the first roller may inhibit items of produce becoming stuck between the gear shaped structures 408, 410 or between the rollers 304, 306.

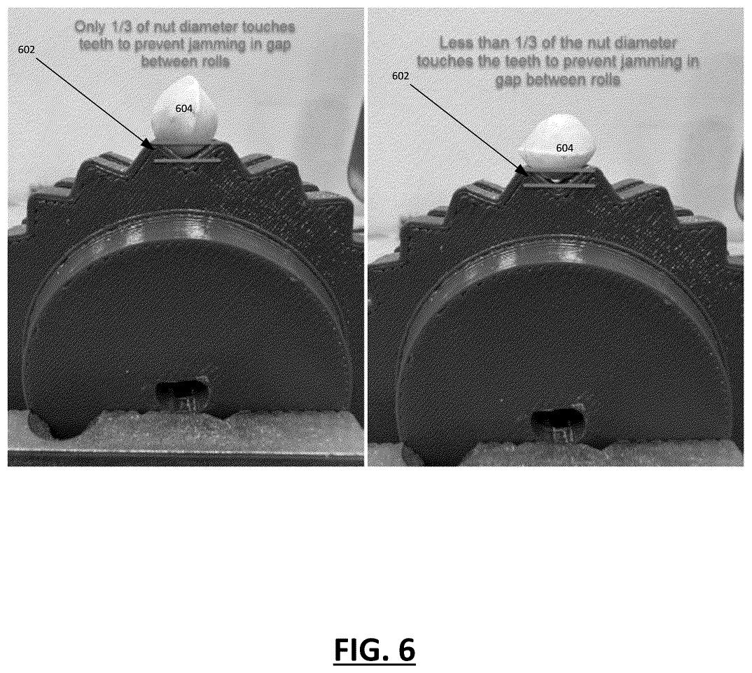

In addition to spacing the gear shaped structures based on the size of produce expected to be processed, the shape of the gear shaped structures may also be tailored to that produce. For example, the teeth of the gear shaped structures may take a variety of forms, such as rectangular, square, round, triangular with a sharp tip, or triangular with a rounded tip. The depth of the teeth may be sized according to the size of the produce to be processed. FIG. 6 is a diagram depicting an example gear shaped structure and an item of produce (a pistachio nut having its hull already removed) being processed. The teeth of the gear shaped structure of FIG. 6 are triangular with a rounded tip. The depth 602 of the teeth (i.e., the distance from the tip of the rounded to the bottom of the triangle) is sized based on the size of the average pistachio nut 604 to be processed. In the example of FIG. 6, the depth 602 is selected to be ⅓ (or less than ⅓) of the average smallest diameter of pistachios expected to be processed. Tooth height may be selected to be short enough to ensure that no more than ⅓ of the hulled pistachio diameter contacts the tooth, to allow the pistachio to tumble and free itself from becoming trapped/jammed in gaps between the rollers.

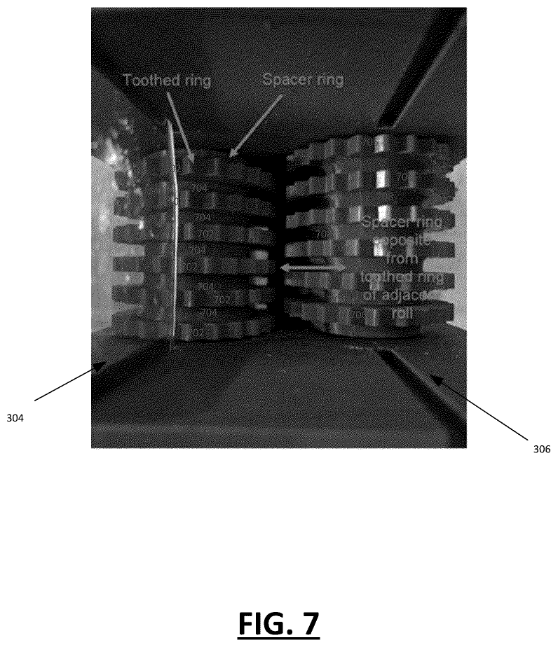

FIG. 7 is a diagram depicting example staggering of gear shaped structures across neighboring rollers. A first roller 304 includes six gear shaped structures 702 separated by five gaps maintained by six spacer rings. Similarly, a second roller 306 includes six gear shaped structures 706 separated by five gaps 708 maintained by six spacer rings. In the example of FIG. 7, the gear shaped structures 702 of the first roller 304 are aligned with gaps 708 of the second roller 306. Similarly, the gear shaped structures 706 of the second roller 306 are aligned with gaps 704 of the first roller 304.

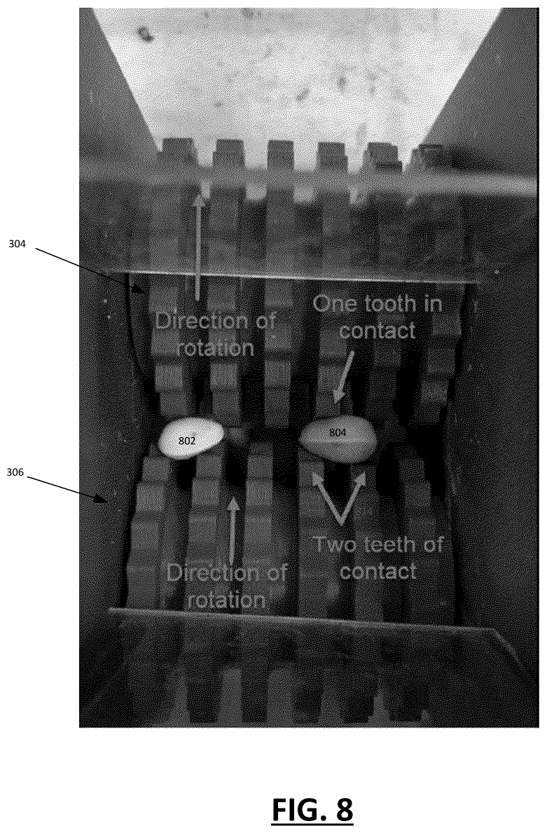

FIG. 8 is a diagram depicting items of produce being processed to remove coverings by gear shaped structures on first and second rolls. A first roll 304 includes gear shaped structures 810, 816 that are turned in the upward direction. A second roll 306 includes gear shaped structures 806, 808, 812, 814 that are also turned in the upward direction. A first pistachio nut 802 is illustrated that has already had its hull removed via the depicted gear shaped structures. Three such gear shaped structures (810 of the first roll 304; 806, 808 of the second roll 306) are in contact with the first pistachio nut 802. A second pistachio nut 804 is illustrated that has also had its hull removed by the gear shaped structures. Three such gear shaped structures (816 of the first roll 304; 812, 814 of the second roll 306) are in contact with the second pistachio nut 804.

In embodiments, the gear shaped structures are spaced such that a minimum of two gear shaped structures (e.g., 812, 814) are in contact with the edges of the pistachio 804 and one gear shaped structure (e.g., 816) is in contact with a center of the pistachio 804. That may provide benefits such as: 1) three gear shaped structures being in contact with the hull may cut and pull away the hull in an efficient manner, 2) unequal pressure is created across the pistachio which results in a tumbling motion to expose remaining hull to the gear shaped structures to aids in hull removal, 3) gaps between the gear shaped structures on an individual roll may aid in the ejection of removed hull material from the structure.

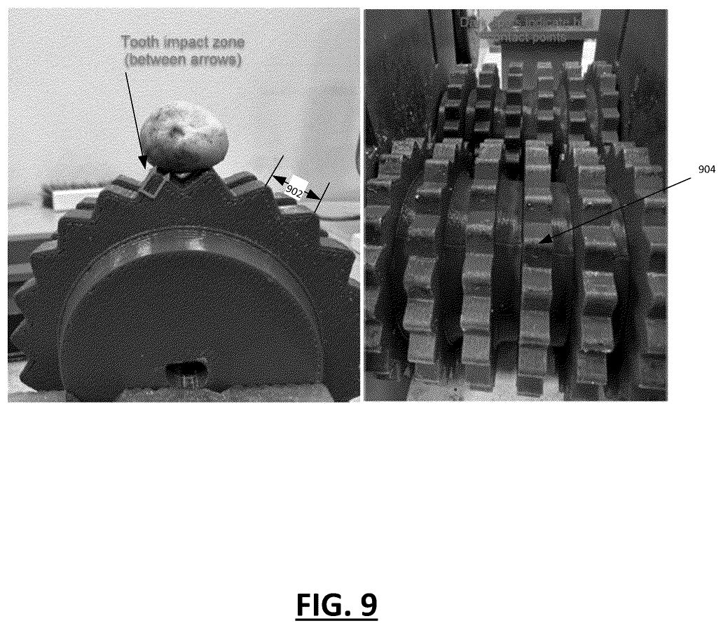

Systems and methods herein may also control the spacing between consecutive teeth of gear shaped structures. FIG. 9 is a diagram depicting tooth impact zones that are controlled via gear tooth spacing. Tooth spacing 902 (i.e., the distance between the highest point of consecutive teeth) may be selected to allow the hull to contact the upper half of the teeth but not sit fully in the root between the teeth. This spacing may make hull cutting more effective by enabling the tips of the teeth to create a point load impact when they contact the hull, increasing the force applied by the teeth to the hull material. This is shown by the dark spots on the teeth FIG. 9 at 904 where teeth have made a cut in pistachio hulls and juices from those hulls have stained the teeth at the contact points.

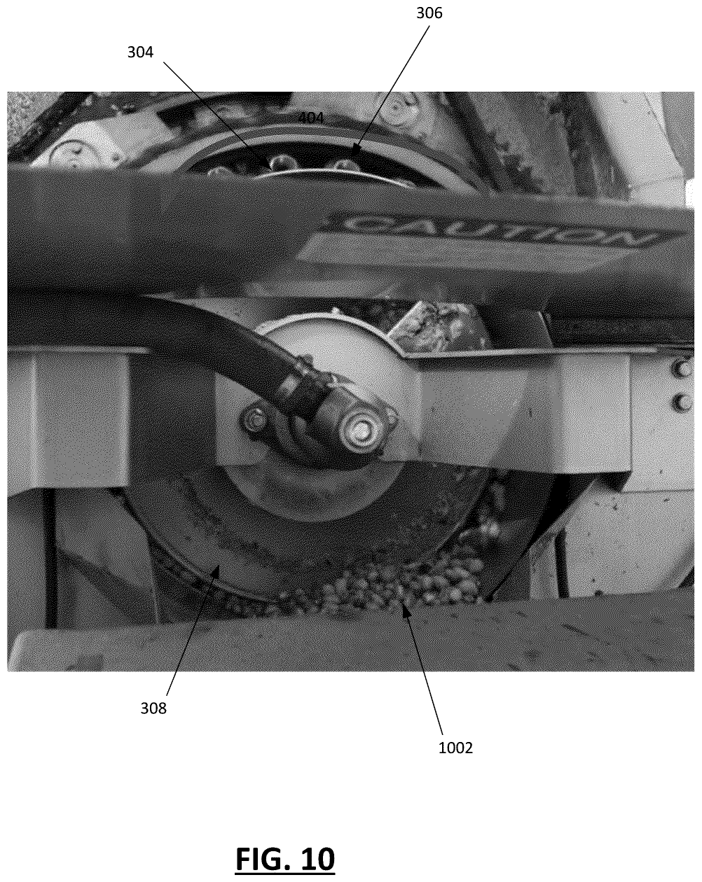

FIG. 10 depicts an end of a system for removing a covering from items of produce. As described above, items of produce may be introduced to a central portion of a structure and translated from one end of the structure to the other end by a feed auger 308. Around that central portion, a plurality of rolls 304, 306 are turned in the same direction. Gear shaped structures are spaced along the length of each of the rolls 304, 306. Simultaneous contact by an item of produce with gear shaped structures on multiple rolls 304 will tend to impart cutting and tearing forces of coverings on that produce, substantially removing those coverings. The weight of several items of produce within the central portion will tend to force other items of produce to contact the rolls 304, 306. Gravity effects will tend to result in produce items to contact rolls at the bottom of the structure. In some embodiments, the structure supporting the rolls 304 will rotate, as indicated by the arrow in FIG. 10, encouraging dislodging of an items of produce or coverings stuck between the rolls 304, 306 and evening wear on the rolls 304, 306. Items of produce are introduced at the far end of the structure, moved toward the near end of the structure via the feed auger 308, and are output in a state where coverings are substantially removed at the near end, as indicated at 1002.

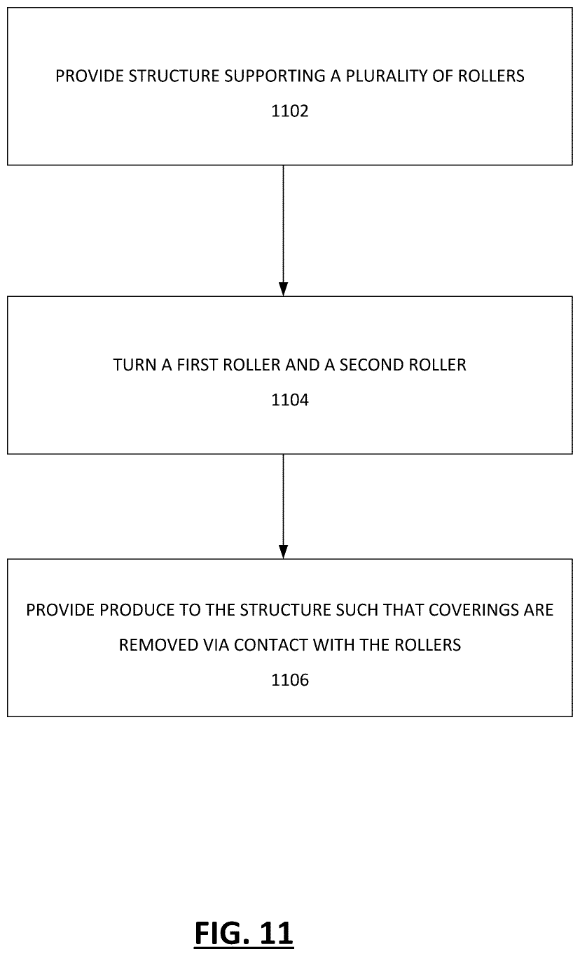

FIG. 11 is a flow diagram depicting a method for removing a covering from produce. At 1102, a structure for supporting a plurality of rollers is provided. At 1104, a first roller is turned and a second roller is turned, where the first roller comprises a first plurality of gear shaped structures, and where the second roller comprises a second plurality of gear shaped structures. At 1106, produce is provided to the structure such that certain of the first and second gear shaped structures contact the produce and remove the covering from the produce when the first roller and the second roller are turned.

While the disclosure has been described in detail and with reference to specific embodiments thereof, it will be apparent to one skilled in the art that various changes and modifications can be made therein without departing from the spirit of the embodiments. Thus, it is intended that the present disclosure cover the modifications and variations of this disclosure provided they come within the scope of the appended claims and their equivalents.

It is claimed:

1. A system for removing a covering from produce, comprising:
a structure for supporting a plurality of rollers, the structure being configured to turn a first roller and a second roller;
wherein the first roller comprises a first plurality of gear shaped structures, and wherein the second roller comprises a second plurality of gear shaped structures;
wherein first and second gear shaped structures are configured to contact the produce and remove the covering from the produce when the first roller and the second roller are turned.

2. The system of claim 1, wherein the first plurality of gear shaped structures are spaced apart from one another by first gaps along the first roller; and
wherein the second plurality of gear shaped structures are spaced apart from one another by second gaps along the second roller.

3. The system of claim 1, wherein one of the first gaps on the first roller is aligned with one of the second plurality of gear shaped structures; and
wherein one of the second gaps on the second roller is aligned with one of the first plurality of gear shaped structures.

4. The system of claim 3, wherein a width of the first gap is less than an average diameter of the produce.

5. The method of claim 4, wherein the first gap is sized to support an item of produce by two gear shaped structures from the first plurality of gear shaped structures and one gear shaped structure from the second plurality of gear shaped structures.

6. The system of claim 1, wherein teeth of the first plurality of gear shaped structures and the second plurality of gear shaped structures are triangular.

7. The system of claim 1, wherein teeth of the first plurality of gear shaped structures are defined by a depth, wherein the depth is approximately ⅓ of an average diameter of the produce.

8. The system of claim 1, wherein teeth of the first plurality of gear shaped structures are defined by a depth, wherein the depth is no more than ⅓ of an average diameter of the produce.

9. The system of claim 1, wherein the structure supporting the plurality of rollers is configured to rotate.

10. The system of claim 9, wherein the system is configured to receive the produce with the covering on at a first end of the structure, and wherein the system is configured to output the produce without the covering at a second end of the structure.

11. The system of claim 1, wherein the first plurality of gear shaped structures are formed of a material comprising ceramic, stainless metal, metal, or durable polymer.

12. The system of claim 1, further comprising:
a rinse station for receiving an item of produce post-covering removal at the structure; and
processing equipment configured for packing, slicing, dicing, drying or storing the item of produce.

13. A method for removing a covering from produce, comprising:
providing a structure for supporting a plurality of rollers;
turning a first roller in a first direction and a second roller in the same direction as the first roller, wherein the first roller comprises a first plurality of gear shaped structures, and wherein the second roller comprises a second plurality of gear shaped structures;
providing produce to the structure such that certain of the first and second gear shaped structures contact the produce and remove the covering from the produce when the first roller and the second roller are turned in the same direction.

14. The method of claim 13, further comprising rotating the structure while turning the first roller and the second roller.

15. The method of claim 13, further comprising spraying the produce with water after the produce has contacted certain of the first and second gear shaped structures.

16. The method of claim 13, further comprising:
removing undesirable material from the produce such as branches and other debris prior to providing the produce to the structure; and
receiving an item of produce having its covering removed from the structure;
rinsing the item of produce; and
providing the item of produce to other equipment for additional processing.

17. The method of claim 13, wherein the cover is removed from a particular item of produce via contact by two gear shaped structures of the first roller and one gear shaped structure of the second roller.

18. The method of claim 13, wherein dozens of items of the produce are provided near simultaneously near the top of the structure.

19. The method of claim 13, wherein the covering is a pistachio hull.

20. The method of claim 13, wherein the produce comprises pistachios, nuts, potatoes, carrots, or a root vegetable.
